(19) United States
(12) Patent Application Publication
(10) Pub. No.: US 2026/0265079 A1
(43) Pub. Date: Sep. 10, 2026

(54) A METHOD OF REFINING AND RECYCLING IRIDIUM

(71) Applicant: Johnson Matthey Public Limited Company, London (GB)

(72) Inventors: Michael Edward BUDD, Royston (GB); Leigh STANTON, Royston (GB)

(21) Appl. No.: 19/490,079

(22) PCT Filed: Jun. 20, 2024
(86) PCT No.: PCT/GB2024/051563

§ 371 Date: Dec. 4, 2025

(30) Foreign Application Priority Data
Aug. 31, 2023 (GB) 2313235.0

(51) Int. Cl. C01G 55/00; C22B 3/44; C22B 11/00

(52) U.S. Cl. CPC C01G 55/002; C22B 3/44; C22B 11/048

(57) ABSTRACT

A method of refining/recycling iridium, the method comprising: adding ammonium chloride to an iridium containing refining/recycling solution comprising iridium dissolved in hydrochloric acid in a first precipitation vessel to precipitate ammonium hexachloroiridate; filtering the precipitated ammonium hexachloroiridate; washing the filtered ammonium hexachloroiridate with a wash mixture of ammonium chloride and water; and recycling the wash mixture of ammonium chloride and water back into a second precipitation vessel, which may be the same vessel as the first precipitation vessel or a different precipitation vessel, to precipitate any iridium dissolved in the wash mixture during washing of the ammonia hexachloroiridate.

### FIELD

The present specification relates to a method of refining/recycling iridium. The method may be applied to a range of iridium containing refining/recycling feeds including those generated from waste catalyst coated membrane materials from fuel cell and hydrogen producing electrolyser applications.

### BACKGROUND

Platinum group metal refining processes can typically involve one or more pyrometallurgical processes, including smelting, to separate platinum group metals from other materials in the feed, followed by acid dissolution of the platinum group metals and a series of hydrometallurgical processes to separate and purify the individual platinum group metals (platinum, palladium, rhodium, iridium, and/or ruthenium). Such processes are known in the art.

Demand for iridium is projected to increase due, at least in part, to the increasing use of iridium in fuel cell and hydrogen producing electrolyser applications. As such, there is a need to provide improved methods for recycling iridium. The present specification aims to address this need.

### SUMMARY

According to the present specification there is provided a method of refining/recycling iridium, the method comprising:
adding, in a first precipitation vessel, ammonium chloride to an iridium containing refining/recycling solution comprising iridium dissolved in hydrochloric acid to precipitate ammonium hexachloroiridate;
filtering the precipitated ammonium hexachloroiridate;
washing the filtered ammonium hexachloroiridate with a wash mixture of ammonium chloride and water; and
recycling the wash mixture of ammonium chloride and water back into a second precipitation vessel, which may be the same vessel as the first precipitation vessel or a different precipitation vessel, to recover any iridium dissolved in the wash mixture during washing of the ammonia hexachloroiridate.

The method recovers iridium as a high purity solid ammonia hexachloroiridate salt while reducing losses of iridium and reducing the usage of ammonium chloride reagent in the process. In this regard, it has been found that a small proportion of ammonium hexachloroiridate can be dissolved in the wash mixture of ammonium chloride and water during the washing step. This is particularly the case if there is too much water in the wash mixture. To recover the iridium from the wash mixture, it has been found to be advantageous to recycle the wash mixture back into a precipitation vessel in order to recover the iridium from the wash mixture. In one configuration, the wash mixture is recycled into the same precipitation vessel used to precipitate the ammonium hexachloroiridate which is the subject of the washing step. Alternatively, in another configuration two or more precipitation vessels can be utilized. For example, the ammonium hexachloroiridate precipitation can be carried out in two precipitation vessels in which case two wash recycling routes can be installed to allow the washings to be redirected from one of the vessels to the other so that the washings can be processed with a further portion of iridium containing recycling solution.

In addition to the advantage of reducing loss of iridium during washing of the precipitated ammonium hexachloroiridate, the method has the additional advantage that by recycling the wash mixture of ammonium chloride and water into the precipitation vessel, there is reduced need for addition of fresh ammonia chloride to the precipitation vessel to achieve complete precipitation of the hexachloroiridate. As such, the method increases iridium yield while simultaneously reducing reagent usage.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a flow diagram of the method of refining/recycling iridium according to the present specification;

FIG. 2 shows a flow diagram of a first configuration of the method using a single precipitation vessel and recycling wash mixture back into the single precipitation vessel; and

FIG. 3 shows a flow diagram of a second configuration of the method using two precipitation vessels and recycling wash mixture from each of the precipitation vessels into the other precipitation vessel.

### DETAILED DESCRIPTION

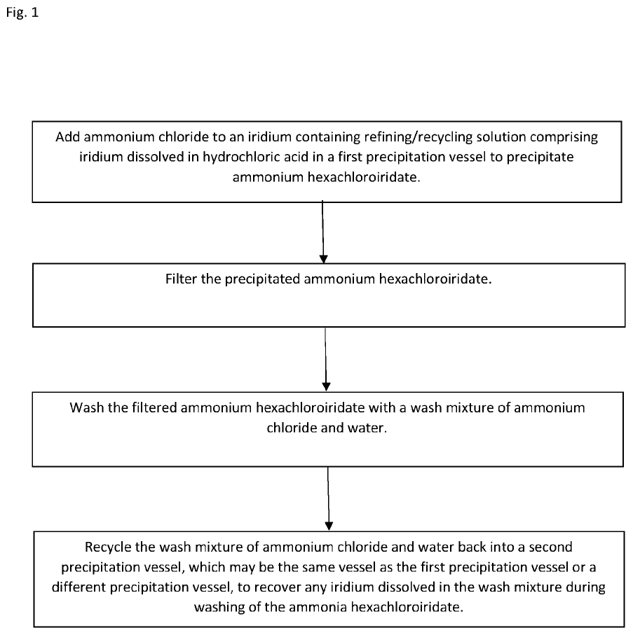

As indicated in the summary section and illustrated in the flow diagram of FIG. 1, the present specification provides a method of recycling iridium, the method comprising: adding, in a first precipitation vessel, ammonium chloride to an iridium containing refining/recycling solution comprising iridium dissolved in hydrochloric acid to precipitate ammonium hexachloroiridate; filtering the precipitated ammonium hexachloroiridate; washing the filtered ammonium hexachloroiridate with a wash mixture of ammonium chloride and water; and recycling the wash mixture of ammonium chloride and water back into a second precipitation vessel, which may be the same vessel as the first precipitation vessel or a different precipitation vessel, to recover any iridium dissolved in the wash mixture during washing of the ammonia hexachloroiridate.

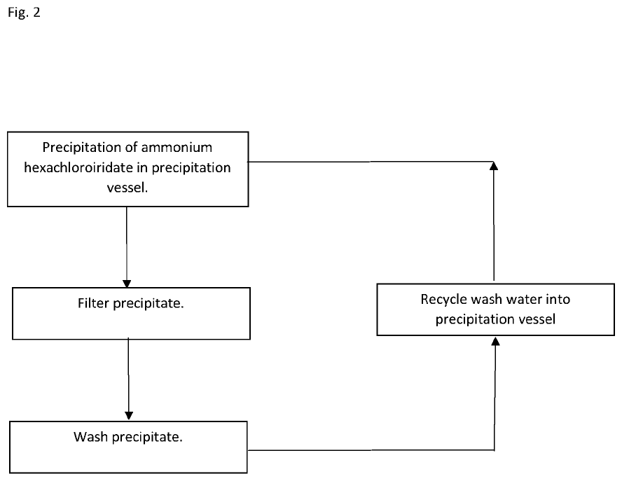

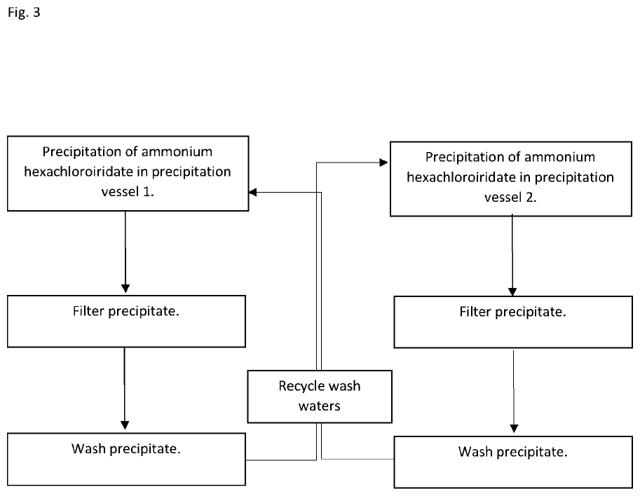

In one configuration, as shown in FIG. 2, the wash mixture is recycled into the same precipitation vessel used to precipitate the ammonium hexachloroiridate which is the subject of the washing step. Alternatively, in another configuration as shown in FIG. 3, two or more precipitation vessels can be utilized. For example, the ammonium hexachloroiridate precipitation can be carried out in two precipitation vessels. Two wash recycling routes can be installed to allow the washings to be redirected from one of the vessels to the other so that the washings can be processed with a further portion of iridium containing recycling solution.

The wash mixture of ammonium chloride and water can be a mixture of saturated ammonium chloride solution and water in a volume ratio 1:2 to 2:1, optionally 1:1. The wash mixture is prepared by loading saturated ammonium chloride solution and water into a vessel and bubbling air through the vessel. If too much water is provided in the wash mixture then this can lead to precipitated ammonium hexachloroiridate dissolving in the wash mixture. The present method ensures that any such ammonium hexachloroiridate dissolved in the wash mixture is recovered by recycling the wash mixture into the precipitation vessel(s).

The recycled wash mixture can be mixed with another portion of the iridium containing refining/recycling solution in the precipitation vessel(s) to precipitate ammonium hexachloroiridate. Ammonium chloride is added to the iridium containing recycling solution in an amount sufficient to provide ammonium ions in excess of iridium. The recycled wash mixture provides at least a proportion of the ammonium ions thus reducing or eliminating the requirement for addition of fresh ammonium chloride to achieve excess ammonium ions in the precipitation vessel(s).

The precipitation, filtering and washing steps can be performed in the precipitation vessel(s) or within a sequence of vessels. The iridium containing refining/recycling solution may have an iridium concentration in a range 40 to 100 g/l and/or an HCl concentration in a range 4 to 5 molar strength. Furthermore, the precipitation of ammonium hexachloroiridate can be performed at one or more of: a temperature in a range 90-100° C.; ambient pressure; and/or a time period of 24 to 48 hours.

The method as described herein may be applied to a range of iridium containing recycling feeds including feeds from fuel cell and hydrogen electrolyser waste materials (manufacturing scrap and/or end-of-life components). For example, a method of recycling iridium from a catalyst coated membrane for a fuel cell or electrolyser can be provided, the method comprising: dissolving the iridium in hydrochloric acid to produce an iridium containing recycling solution; and processing the iridium containing recycling solution using the method according to any preceding claim.

In light of the above, it will be appreciated that the present specification provides a routing of final iridate filter cake washings back into the process for rework with a next batch of iridate and recovery of the lost iridium. Following precipitation of final ammonium hexachloroiridate in a PGM refining process, the salt is filtered and washed with a mixture of ammonium chloride and water (e.g., a 1:1 solution of saturated ammonium chloride and water).

The wash mixture can be prepared (e.g., manually) by loading saturated ammonium chloride solution and water into the precipitation vessel, pulling into a vacuum transfer flask, and mixing in the flask by bubbling air through the bottom outlet. If too much water is added to the wash mixture this causes the iridate to redissolve during washing. That is, during washing, some of the iridium redissolves and this is normally lost to foots liquor.

As such, new process routes have been installed which allow the washings to be redirected back into the precipitation vessel and can be reworked with the next batch. While final iridate precipitation can be carried out in two vessels, typically only one vessel is in process at a time. Two new routes have been installed to allow the washings to be redirected into the empty adjacent vessel so that it can be reworked with the next final iridate batch. Doing this recycle also removes the need for addition of solid ammonium chloride to ensure required excess of ammonium ions present to give complete precipitation.

The new process avoids final iridate washings being lost to foots and the new routes allow a way for recovering the iridium dissolved during washing and removes/reduces the requirement for fresh ammonium chloride additions. The benefits of the invention thus include reduced losses of iridium from the process and a reduction in reagent use. Reducing iridium losses from a refining circuit improves circularity of this rare resource.

While this invention has been particularly shown and described with reference to certain examples, it will be understood to those skilled in the art that various changes in form and detail may be made without departing from the scope of the invention as defined by the appended claims.

1. A method of refining/recycling iridium, the method comprising:
adding, in a first precipitation vessel, ammonium chloride to an iridium containing refining/recycling solution comprising iridium dissolved in hydrochloric acid to precipitate ammonium hexachloroiridate;
filtering the precipitated ammonium hexachloroiridate;
washing the filtered ammonium hexachloroiridate with a wash mixture of ammonium chloride and water; and
recycling the wash mixture of ammonium chloride and water back into a second precipitation vessel, which may be the same vessel as the first precipitation vessel or a different precipitation vessel, to recover any iridium dissolved in the wash mixture during washing of the ammonia hexachloroiridate,
wherein the recycled wash mixture is mixed with another portion of the iridium containing refining/recycling solution in the second precipitation vessel to precipitate ammonium hexachloroiridate, wherein the ammonium chloride is added to the iridium containing refining/recycling solution in an amount sufficient to provide ammonium ions in excess of iridium, the recycled wash mixture providing at least a proportion of the ammonium ions thus reducing or eliminating the requirement for addition of fresh ammonium chloride to achieve excess ammonium ions.

2. The method according to claim 1,
wherein the wash mixture of ammonium chloride and water is a mixture of saturated ammonium chloride solution and water in a volume ratio 1:2 to 2:1, optionally 1:1.

3. The method according to claim 1,
wherein the wash mixture is prepared by loading saturated ammonium chloride solution and water into a vessel and bubbling air through the vessel.

4-5. (canceled)

6. The method according to claim 1,
wherein the precipitation, filtering and washing steps are performed in the precipitation vessel or vessels or in a sequence of vessels.

7. The method according to claim 1,
wherein the first and second precipitation vessels are two separate vessels, and the wash mixture from the first precipitation vessel is recycled into the second precipitation vessel to be processed with another portion of the iridium containing refining/recycling solution.

8. The method according to claim 1,
wherein the iridium containing refining/recycling solution has an iridium concentration in a range 40 to 100 g/l.

9. The method according to claim 1,
wherein the iridium containing refining/recycling solution has an HCl concentration in a range 4 to 5 molar strength.

10. The method according to claim 1,
wherein the precipitation of ammonium hexachloroiridate is performed at one or more of: a temperature in a range 90-100° C.; ambient pressure; and/or a time period of 24 to 48 hours.

11. A method of recycling iridium from a catalyst coated membrane for a fuel cell or electrolyser, the method comprising:
dissolving the iridium in hydrochloric acid to produce an iridium containing recycling solution; and
processing the iridium containing recycling solution using the method according to claim 1.
